(19) United States
(12) Patent Application Publication
(10) Pub. No.: US 2003/0031980 A1
(43) Pub. Date: Feb. 13, 2003

(54) Airways, lungs, and gastrointestinal tract protection system aginst aspiration and ingestion of foreign dental bodies in conscious and consciously sedated dental patients

(76) Inventor: Zaidoon Rakad Owais, Kansas City, MO (US)

Correspondence Address: Zaidoon Rakad Owais, 5050 Oak St., Apt. 811, Kansas City, MO, 64112, US

(21) Appl. No.: 09/923,619

(22) Filed: Aug. 7, 2001

(51) Int. Cl. A61C 5/14; A61C 5/12

(52) U.S. Cl. 433/136; 433/138; 433/139

(57) ABSTRACT

The airways, lungs and gastrointestinal tract protection system in conscious and consciously sedated dental patients is the first system that provides reliable comprehensive protection against aspiration and ingestion of dental objects during various dental procedures. It is also the first system that uses teeth and/or elastic forces for stability and the malleability nature of some metals to perfectly seal and secure the airways the lungs, and the gastrointestinal tract.

The protector also provides an easier and less time consuming alternative to the isolation rubber dam (concerning the protection of the air and food passages not the isolation of teeth) when the use of the rubber dam is difficult or time consuming. In these circumstances cotton rolls can provide isolation.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

Safety of dental patients is a fundamental issue in dentistry. In fact, safety is the number one issue in the American Dental Association and the JCAHO at the present time. Protecting the airways, lungs and gastrointestinal tract of the dental patient against aspiration and ingestion is one of the most important aspects of this safety. Foreign body aspiration can result in a spectrum of consequence ranging from minimal symptoms to respiratory compromise, failure and death. If foreign bodies in the gastrointestinal tract do not come out spontaneously, then infection, bleeding, perforation, or blockage are possible. Unfortunately, dentists have to deal with these risks every day.

The method available to protect a conscious dental patient from aspirating or ingesting foreign dental objects during dental procedures is a piece of gauze floating in her/his throat. Over the years, this method failed and is still failing in preventing aspiration or ingestion of dental objects due to the following reasons:

1) It's very difficult to seal the airways and gastrointestinal tract with this gauze because it impossible to have it completely adapted to the anatomy of the oral cavity

2) Even if the gauze is adapted to the anatomy of the oral cavity, the gauze is not attached to anything and it can be moved very easily by the fingers and the instruments of the dentist, the tongue of the patient . . . etc, rendering the airways, the lungs and the gastrointestinal tract vulnerable to aspiration, ingestion and their complications.

What makes the failure of this method more obvious is that even when experienced dentists use it carefully, instances of aspiration and ingestion still occur.

Aspiration of a small foreign dental object may lead to the transmittal of infectious material to the lungs causing pneumonia or lung abscess. Emphysema and atelectasis are other possible complications. It is possible that, if this object is not removed in the right time, complications may lead to death.

Aspiration of a larger dental object may lead to complete obstruction of the airway and acute respiratory distress, which if not treated immediately may lead to death.

Aspiration of sharp dental objects can lead to trauma, Internal bleeding, or laryngeal spasm. Infection and/or death are always a possibility in any of these cases.

The risk of aspiration is higher in children, and it is easy to totally obstruct their trachea, which has a diameter of a pencil. The risk is also higher in elderly, especially those with neuralgic disorders and decreased gag reflexes due to senile dementia, Parkinson's disease, seizures, strokes, trauma to the CNS and mental retardation. Dental patients undergoing dental procedures with conscious sedation are another category of dental patients at higher risk.

In about 1 of every 3 patients, aspiration is misdiagnosed. If treatment is delayed because of this, the inhaled object may cause bleeding or infection and eventually death.

Prevention is better than cure and management of aspiration is not risk free. In acute complete airway obstruction, if the airways are not opened immediately, the patient may die. Heimlich maneuver, which is usually used in such situations has the risk of damaging the liver, especially in children, it also may cause traumatic rupture of the stomach or abdominal aortic thrombosis. Heimlich maneuver is also a risky procedure in pregnant female patients, if not contraindicated.

Cricothyroidotomy has the risk of injuring the adjacent blood vessels of the neck when used by less experienced persons, this is true, especially, in children.

Bronchoscopy is not always successful in removing dental objects from the lungs, and can also cause some complications like: vocal cord injury, tracheal laceration, and postoperative subglottic edema.

If bronchoscopy fails, surgery is the alternative. It does have it's own complications; it usually results in the removal of part of the involved lung. Not mentioning the general complications of surgery and anesthesia, which include death, lung surgery offers it's specific complications. Cardiovascular complications include: sepsis, strokes, myocardial infarction, pulmonary embolism, and hemorrhage, which is the most common cardiovascular complication and the most common cause of rethoracotomy. Other complications are acute lung injury and respiratory failure. Whether complications after surgery occur or not, meticulous medical care and follow up is always needed.

The above complications assume that we are dealing with healthy patients; complications in patient with prior existing respiratory or other medical problems are more severe.

To all of the above complications we can add the extensive emotional suffering of the dentist and the cost of the medical care needed when these complications occur. Even if we are lucky and the patient swallowed the object instead of inhaling it, radiographic examination is mandatory. If the object that is swallowed is sharp, or it does not come out spontaneously, further medical intervention is necessary.

Examples of dental objects that can be aspirated or ingested during dental procedures are: all types of crowns and bridges, inlays and onlays, space maintainers, partial dentures, orthodontic bands and braces, extracted teeth or broken pieces of extracted teeth, broken pieces of fillings during removal of old fillings, dental wooden wedges, parts of dental implants, broken dental burs, endodontic files and posts (when it is difficult to use a dental rubber dam, because of difficulty in stabilizing it on the teeth due to a variety of circumstances such as grossly decayed crowns), a 7 cm long air water tip syringe and even the screwdriver used for implants, . . . etc.

### REFERENCES

1) Bergermann M. Donald P J. aWegen D F. Screwdriver aspiration. A complication of dental implant placement. International Journal of Oral & Maxillofacial Surgery.21(6)339-41, December 1992.

2) Biron C R. Quick retrieval of swallowed objects prevent further complications such as peritonitis. RDH. 17(5):38-40, May 1997.

3) Chouhan S P. Das gupta H K. A beveled tube slide on a fibroptic gastroscope for removal of a dental prosthesis from the esophagus. Endoscopy. 30(12):S42, March 1998.

4) Dupre M W, Silva E, Brotman S: Traumatic rupture of the stomach secondary to Heimlich maneuver. Am J Emerg Med. 11(6): 611-2. November 1993.

5) Fung S T. Poon Y Y. Chong Z K. Jawan B. Lee J H. Removal of an aspirated prosthetic tooth by tracheal backflow air. Anesthesia & Analgesia. 90(4):993-4, April 2000.

6) Gelford, B: Foreign Bodies, Trachea. eMedicine Journal. 1(9), September 2000.

7) Gelineck J. [swallowed tooth root file]. [Danish] Ugeskrift for Laeger. 146(29):2162-3, Jul. 16, 1984.

8) Krein A E. Spindler R. Elert O [Prophylaxis and therapy of infectious complications of lung surgery]. [German] Zentralblatt fur Chirurgie. 124 Suppl 4:23-7, 1999

9) LeJeune F E Jr. Foreign bodies in the tracheobronchial tree and esophagus. Surgical Clinics of North America. 46(6): 1501-12, December 1996.

10) Licker M. de perrot M. Hohn L. Tschopp J M. Robert J. Frey J G. Schweizer A. Spiliopoulos A. Perioperative mortality and major cardio-pulmonary complications after lung surgery for non-small cell carcinoma. Europian Journal of Cardio-Thoracic Surgery. 15(3)314-9, March 1999.

11) Liu Z. Qin C. Duodenal perforation after removal of a swallowed tooth. Gastrointestinal Endoscopy. 39(6):857-8, November-December 1993.

12) Muro K. Yanagihara K Kurata M. [Severe respiratory distress caused by dental foreign object]. [Japanese] Nihon Kokyuki Gakkai Zasshi. 36(12):1023-6, December 1998.

13) Nageris B. Feinmesser R. Dentures in the esophagus complicated by pneumomediastinum. Ear, Nose, & Throat Journal. 69(11):126-7, November 1990.

14) Oguz F. citak A. Unuvar E. Sidal M. Airway foreign bodies in childhood. International Journal of Pediatric Otorhinolaryngology. 52(1):11-6, Jan. 30, 2000.

15) Pinals M. Pinals D. Tracy J D. Brandstetter R D. Expectation of an occult foreign body six asymtomatic years after aspiration. Chest. 103(6):1930-1, June 1993.

16) Pogorzelski A. Zebrak J. [Scar changes in bronchus caused by a foreign body]. [Polish] Wiadomosci Lekarskie. 48(1-12):140-2, January-June 1995.

17) Rajesh P B. Goiti J J. Late onset tracheo-oesophageal fistula following a swallowed dental plate. European Journal of Cardio-Thoracic Surgery. 7(12):661-2, 1993.

18) Roas M. Klancir S B. Dodig S. Koncul I. [Foreign bodies in the airways in children]. [Serbo-Croatian (Roman)] Lijecnicki Vjesnik. 123(3-4):66-9, March 2000.

19) Roehm E F. Twiest M W. Williams R C Jr. Abdominal aortic thrombosis in association with an attempted Heimlch maneuver. JAMA. 249:1186-7, Mar. 4, 1983.

20) Saito S. [Bronchial-esophageal foreign bodies in dentistry]. [Japanese] Nippon Shika Ishiki Zasshi—Journal of the Japan Dental Association. 37(5): 479-84, 1984.

21) Sane S M. Faeber E N. Belani K K. Respiratory foreign bodies and Eikenella corrodens brain abscess in tow children. Pediatric Radiology. 29(5):327-30, May 1999.

22) Sharma H S. Sharma S. Management of laryngeal foreign bodies in children. Emergency Medicine Journal. 16(2): 150-3, March 1999.

23) Sirbu H. Busch T. Aleksic I. Lotfi S. Ruschewiski W. Dalichau H. Chest re-exploration for complications after lung surgery. Thoracic & Cardiovascular Surgeon. 47(2):73-6, April 1999.

24) Soudack M. Fischer D. [Left lung atelectasis due to tooth in the left bronchus]. [Hebrew] Harefuah. 136(11):911-2, Jun. 1, 1999.

25) Stjernquist-Desatnik A. Cwikiel W. [Foreign body can be extracted by radiologic intervention technique. A case report with a successful extraction of a pivot tooth from periphral bronchi]. [Swedish] Lakartidningen. 97(8):846-9, Feb. 23, 2000.

26) Strassler H E. Hasler J F. Ingestion and aspiration of foreign bodies in dental practice: tow case reports. Journal of the Bultimore College of Dental Surgery. 36(1):1-5, September 1983.

27) Tan H K. Brown K. Mcgill T. Kenna M A. Lund D P. Healy G B. Airway foreign bodies (FB): a 10-year review. International Journal of Pediatric Otorhinolaryngology. 56(2):91-9, Dec. 1, 2000.

28) Vagner E A. Subbotin V M. Davidov M I. Repin V N. Titlianova Z A. Vorontsov A P. [Surgical policy in gastrointestinal tract foreign bodies]. [Russian] Khirurgiia. (5):24-8, 1999.

29) Zaytoun G M. Rouadi P W. Baki D H. Endoscopic management of foreign bodies in the tracheobronchial tree: predictive factors for complications. Otolaryngology Head & Neck Surgery. 123(3):311-6, September 2000.

30) Zerella J T. Dimler M. Mcgill L C. Pippus K J. Foreign body aspiration in children: value of radiography and complications of bronchoscopy.

31) Zizmann N U. Fried R. Elsasser S Marinello C P. [The aspiration and swallowing of foreign bodies. The management of the aspiration and swallowing of foreign bodies during dental treatment]. [Review][15 refs] [French, German] Schweizer Monatsschrift fur Zahnmedizin. 110(6):619-32, 2000.

### BRIEF SUMMARY OF THE INVENTION

The airways, lungs, and gastrointestinal tract protection system against aspiration and ingestion of foreign dental bodies in conscious and consciously sedated dental patients (will be referred to as the protector, later) is a group of designs that are used for prevention of aspiration, ingestion and their complications during dental treatment. A very large number of designs is possible, only few examples are discussed here.

In it's simplest design, the protector is composed of a 2 layered medical gauze, that is resistant to tear, sandwiching an upper and lower malleable metal strips or frames at it's upper and lower margins successively. The upper malleable metal frame is adapted to the anatomy of the hard palate from the palatal gingival margin of an upper right posterior tooth (usually a molar) to a posterior tooth in the opposite (left) side of the upper jaw. The lower malleable metal frame is adapted to the anatomy of the floor of the mouth without impinging on it or interfering with the frenum of the tongue. It extends from the lingual gingival margin of a lower right posterior tooth to a lower posterior tooth on the opposite (left) side. Both frames are touching the soft tissue that they extend over without harming it.

Each of the tow edges of each the upper and lower malleable metal frames is attached to an elastic ring that fits on the neck of a posterior tooth in a different quadrant in the mouth to stabilize the device.

One of the main ramifications to this design is to increase the stability of the protector by using other intra or extraoral elastic devices either with or without the elastic rings. (Details are in the detailed description of the invention).

When replacing the gauze mentioned above with a continuous sheet (like a rubber dam sheet for example), this protector may provide a great alternative to the rubber dam (regarding aspiration and ingestion not isolation) when it's impossible, difficult, or time consuming to use the later (some dentists do not use a rubber dam during root canal treatment because sometimes it is difficult or time consuming, this has lead to the death of some dental patients because of aspiration of root canal instruments).

This system will provide an excellent seal to the airways, lungs, and the gastrointestinal tract of the patient against aspiration and ingestion of any foreign dental object during dental procedures. This will enhance the safety of dental patients, decrease the stress on the dental professionals and patients caused by the fear of aspiration or ingestion, reduce the costs spent on medical care that can be avoided and prevent extra charges by the insurance company.

Secondary functions of this protector are to separate the teeth from the tongue during a dental procedure. This can be important when dealing with moisture sensitive techniques like cementing a crown. This separation can also protect the tongue from materials that can burn it like phosphoric acid used during placing a composite filling, this is true especially when replacing the gauze with a continuous sheet (with no perforations).

This system, to the best of my knowledge, is the first and only system that provides conscious and consciously sedated dental patients with a stable, dependable and excellent airways, lungs and gastrointestinal tract protection against aspiration or ingestion of foreign dental objects during various types of dental procedures (A rubber dam can not be used for crowns or extractions). In addition, thought the protector is not meant to replace the rubber dam in root canal treatment, it is cheap, and may be easier and less time consuming than the rubber dam, and can be used by dentist who do not use, or do not like to use, the rubber dam for the root canal treatment).

### BRIEF DESCRIPTION OF THE SEVERAL VIEWS OF THE DRAWING

FIG. 1: A view of the medical gauze (A) composed of 2 layers.

FIG. 2: A view of one of the elastic rings (B).

FIG. 3: A view of the upper malleable metal strip or frame (C).

FIG. 4: A view of the lower malleable metal strip or frame (D).

FIG. 5: A view of the basic design of the airways, lungs and gastrointestinal tract protector against aspiration and ingestion in conscious dental patients.

It shows the gauze (A) sandwiching the upper (C) and lower (D) metal frames.

It also shows the upper and lower metal frames adapted to fit the hard palate and the floor of the mouth successively.

It also shows the elastic rings (B) attached to the edges of the metal frames.

It also shows the part of the gauze extending extraorally (A1)

The tilt in the vertical lines of the gauze is meant to show that the gauze is not stretched between the frames, but rather it is concave and passive.

FIG. 6: A view from the lingual side that shows how the straight lower metal frame (D) is bent to continue forward and medially as it reaches the floor of the mouth from the lingual gingival margin. (This view is from the lower left quadrant).

FIG. 7: A view that shows how one of the elastic rings is attached to lower metal frame using electrical power for fusion of the frame around the elastic ring. (This view is from the lower left quadrant).

FIG. 8: A mesial view showing the mesial part of one of the elastic rings (B) surrounding the neck of the permanent lower left first molar (E).

It also shows how the frame goes medially a distance of (F), which is about 3-5 mm, before it goes downward to avoid the pressure on the lingual gingival margin.

FIG. 9: An occlusal view of FIG. 8, showing how the elastic ring surrounds the tooth (E) after it was flossed around this tooth.

FIG. 10: A view of a ready made lower malleable metal frame (G) formed in the shape needed to simulate the anatomy of the parts of the mouth that it will touch. In other words, the shape of this frame is made to simulate the shape of the straight frame after it is bent to adapt to the anatomy of the mouth.

FIG. 11: A view of the protector with tow additional ramifications:

First: a thread (I, J, K) that is used to pull the angles of the gauze intraorally when there is a need to check the occlusion or use occlusal force during dental procedures.

Second: A U shaped bent (H) in the upper and lower frames to increase the adjustability of the frames and the device to the different sizes of different mouths.

FIG. 12: A larger view of the U bent (H) mentioned above in the second ramification of FIG 11.

FIG. 13: A view of another ramification, the metal strips or frames (C), (D), and (G) mentioned in FIG. 3, FIG. 4, and FIG. 10 successively can be replaced with strips or frames that have the same shapes but are wavy (L) instead of being straight to increase the adjustability of these frames and the protector to the different sizes of different mouths. The frequency and height of the waves can vary depending on the malleability of the metal used or the need. (L1) is one example of a possible shape of the waves or wavy frame.

FIG. 14. A view of the protector when we can not place the elastic rings on the most posterior teeth because of different reasons mentioned in the detailed description of the invention below. There is a part (O) and (O1) of frame (M) and (N) successively extending posteriorly from the area where the elastic ring is attached until it reaches an area distal to the last tooth.

Also this FIG shows that it is possible to use more than one elastic ring in each quadrant to improve the stability of the protector.

FIG. 15 is a mesial view of an intraoral buccal elastic strip or frame (Q) and a lingual spring (Q12) surrounded by soft material (P) and (P1) respectively. The buccal piece is attached to the elastic rings (B) and the lingual part is attached to the frames directly. (R) is the oral mucosa covering the cheek.

FIG. 15A is a view of another kind of elastic piece that can be adjusted to fit the width of the mouth opening of the patient. (Q14) is the ring. (Q15) and (Q16) are the arms of the elastic piece.

FIG. 15B is a view of a design for a spring elastic piece in which each ring goes inside the ring after it so that the spring will come very short when the patient closes her/his mouth, instead of bending and interfering with the tissues of the mouth.

FIG. 16: A buccal view of an intraoral elastic bar (Q2). (Q21) is the part that attaches the elastic piece to the elastic ring (B). (Q22) and (Q24) are the parts of the elastic piece that extends vertically adjacent to the alveolar ridges. (Q23) is made when there is no enough space in the posterior part of the upper vestibule for the plastic piece to extend in, mainly because of interference of bony structures when the patient opens or closes his mouth.

FIG. 17: A view of a protector that can be used in edentulous patients during the process of getting implants. There are extensions (U) of the lingual frame (U2) connecting it with the buccal frame (U1), without interfering or covering the areas where the flaps will be raised or the implants will be inserted in the alveolar ridges (T1) and (T2). (S1) and (S2) are the upper and lower buccal sulci respectively, (S11) is the hard palate, (S21) is the lingual vestibule or sulcus. (S3) is the tongue. (Q1), (Q11) and (Q12) are the buccal distal, and lingual springs successively.

FIG. 18: A view of an extraoral elastic piece placed buccaly. (Q25) is the part that extends from the elastic ring to the angle of the mouth. (Q26) is a U shaped bent to avoid the lips. (Q27) is the part of the elastic piece extending extraorally.

FIG. 19. An extraoral view of another design using extra oral parts for stability in dentate or edentulous patients. Instead of using teeth for stability, which are not available in this case, the protector uses the ears to stabilize the upper portion and the chin to stabilize the lower portion by hooking the ends of the upper frame (V1) around the ears and by connecting the ends of the lower frame (V2) around the chin. One or more U bents can be added to improve adjustability, and the wavy design shown in FIG. 13 is always a choice. This design is not elastic.

FIGS. 20 and 21: Tow views of the device that can be used in fitting the elastic rings around the teeth when not using the buccal elastic pieces.

FIG. 22: A view of the tow threads (X1) and (X2) attached to the elastic ring (B). These tow threads help in fitting the elastic rings around the teeth when not using the buccal elastic pieces.

FIG. 23: A view of tow instruments used in the removal of the elastic rings (B) from around the teeth. (Y1) is used to remove the elastic ring intact by inserting the tow tips (Y11) and (Y12) between the tooth and the ring and pulling occlusally. (Y2) is used to cut the ring by the blade (Y21) after inserting the tip between the tooth and the ring, this may be needed when it is difficult to remove the ring intact.

FIG. 24: A view of the clamp-like design that can be used in the malleable frames, the elastic pieces, and/or the cheek retractor . . . etc. to be attached to the rubber rings and/or the gauze. This may be useful when using non-disposable malleable frames, elastic pieces, and/or cheek retractor . . . etc

NB: All of these views are examples and do not show all the possible designs of the protection system.

### DETAILED DESCRIPTION OF THE INVENTION

1) The simplest airways, lungs and gastrointestinal protector against aspiration and ingestion in conscious dental patients is composed basically of at least 2 layers of a medical gauze that is resistant to tear, 2 malleable metal strips or frames, and 4 elastic rings.

2) FIG. 1 shows the medical gauze mentioned in 1 above. It has a rectangular shape, the upper and lower margins being the longer margins. The length of the gauze ranges from about 6 cm for very small mouths (children) to 22 cm for very large mouths. The width varies from about 6 cm to 18 cm depending on the size of the mouth of the patient.

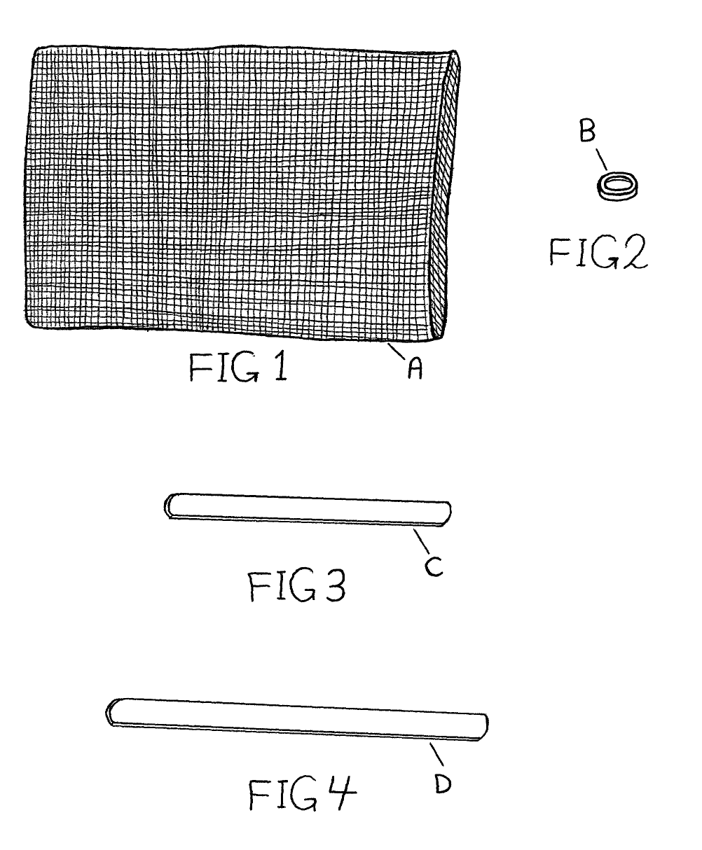

3) FIG. 2 shows one of the elastic rings mentioned in 1 above. It is composed of a rubbery material. It can be stretched to increase its diameter several times. The internal diameter of each ring varies from about 1 mm to 4 mm depending on the size of the tooth to be surrounded by the ring. The height of the ring ranges from about 1 to 2.5 mm and the thickness of about 0.5 to 1.5 mm. It is possible to have part of the ring made of dental floss; this will make it easier to floss the ring between teeth.

4) FIG. 3 and FIG. 4 show the upper and lower malleable strips or frames successively. These frames, mentioned in 1 above, are composed mainly from an alloy that has the capacity to be malleable. An example of this is the metal strips used in some medical facial masks to make the upper part of the mask malleable and adaptable to the bridge of the nose and the cheeks. The length of the upper frame varies from about 4 to 20 cm, and for the lower frame from about 5 to 20 cm depending on the size of the mouth of the patient. The width of each frame is about 3 to 7 mm and the thickness is between 0.5 to 1.5 mm. The malleability of these frames makes it easy to adapt them to the hard palate and the floor of the mouth. All margins and edges of these frames are rounded to avoid trauma to the soft tissue of the patient. Wires with same malleability can be used as an alternative

5) FIG. 5 shows that the upper and the lower frames, mentioned in 4 above, are sandwiched by the 2 layers of the gauze mentioned in 2 above at the upper and lower margins of the gauze successively. The frames are firmly attached to the margins of the gauze. Before sandwiching the frames by the gauze, it is possible to wrap or coat them with 2 or more layers of a soft sheet like a gauze, cotton, wool, plastic or any other soft sheet, this will make the frames less traumatic to the soft tissues of the patient and more securing (completely adapting to the area where they touch the tissues of the patient).

6) FIG. 5 also shows that the upper frame, mentioned in 5 above, is bent to assemble the shape of the hard palate from the palatal gingival margin of an upper posterior tooth (usually a molar) to the palatal gingival margin of a posterior tooth in the opposite side of the upper jaw. Tow designs are possible for the upper frame, it can extend from one side to the other parallel to the hard palate and the coronal plane (one of the anatomical planes), or it can be tilted forward and medially few millimeters after it leaves the tooth surface to pass just behind the incisive papilla, this forward bent (not shown) will decrease the possibility of having any gag reflex in patients who are very sensitive. In all cases the frame is parallel to the anatomy of the part of the hard palate that it extends over.

FIG. 5 also shows, the lower frame, mentioned in 5 above, is adapted to the anatomy of the floor of the mouth without impinging on it or interfering with the frenum of the tongue. It extends from the lingual gingival margin of a lower posterior tooth downward to the floor of the mouth then it is bent, as shown in FIG. 6 to continue forward and medially on the lingual side of the alveolar ridge or on the floor of the mouth without impinging on it. In the midline, anterior to the frenum of the tongue and lingual to the lower tow central incisors it meets with (almost) a mirror image, which ends on the lingual gingival margin of a lower posterior tooth on the opposite side.

In addition, FIG. 5 also shows an elastic ring attached to each of the ends of the frames.

FIG. 5 also shows how each elastic ring extends laterally from the ends of the frames.

7) FIG. 6 is a view from the lingual side that shows how the straight lower metal frame (D) is bent to continue forward and medially as it reaches the floor of the mouth from the lingual gingival margin.

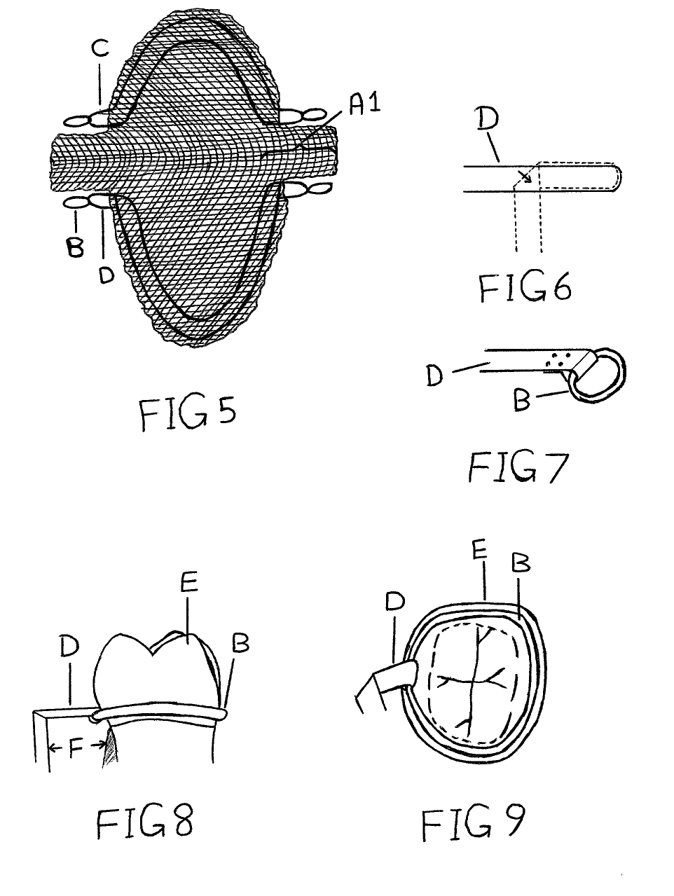

8) FIG. 7 shows how the edge of the frame rotates around one of the elastic rings and is fused with itself by electrical power. Alternatives to this method are compression power, or rotating the edge of the frame more than once around the elastic ring, . . . etc.

9) FIG. 8 shows that about 2 to 4 mm occlusal to the level where the frames, mentioned in 6 above, meet the level of the gingival margin, each end of these frames is bent laterally to form approximately a 90 degree angle with the lingual surfaces of the teeth that will be used to stabilize the device. The amount of the angle here is not critical. The only purpose of this bent is to avoid impinging on the lingual gingival margin by the ends of these frames when the device will be attached to the teeth. (F) is the safety distance between the frame and the gingival, it can be from 1 to 5 mm or more.

10) Again, FIG. 5 also shows that at the site where the frames, mentioned above in 7, are bent laterally to avoid impingement on the gingival margin, they pierce the posterior layer of the gauze mentioned in 2 above and they 14 are not sandwiched in the gauze any more. This is not mandatory, the design can have all the length of the frames sandwiched in the gauze, and an advantage of this is that the frames will not contact the tissues of the mouth, which mean less potential trauma to the patient. The elastic rings must not be sandwiched in the gauze.

The device is ready to use.

11) The elastic rings are stretched, one at a time, the posterior part of it is flossed between the distal surface of the tooth that it will be attached to and the mesial surface of the tooth posterior to it (if any), the anterior part is flossed between the mesial surface of the tooth that it will be attached to and the distal surface of the tooth anterior to it (if any). The ring is then released to surround the neck of the posterior tooth; this step is repeated for each of the other rings. The result is that each ring is surrounding a posterior tooth in a different quadrant of the mouth. FIGS. 8 and 9

12) The upper frame is then adapted to the shape of the hard palate and the lower frame to the floor of the mouth or, preferably, to the inferior part of the lingual surface of the lower alveolar ridge by lightly pushing them against these anatomical structures. The lateral ends of the gauze mentioned in 2 above are then spread laterally and extraorally (A1) to completely seal the buccal sulci of the mouth.

13) Any dental procedure can be performed now safely without having the risk of aspiration or swallowing of a foreign dental object by the patient.

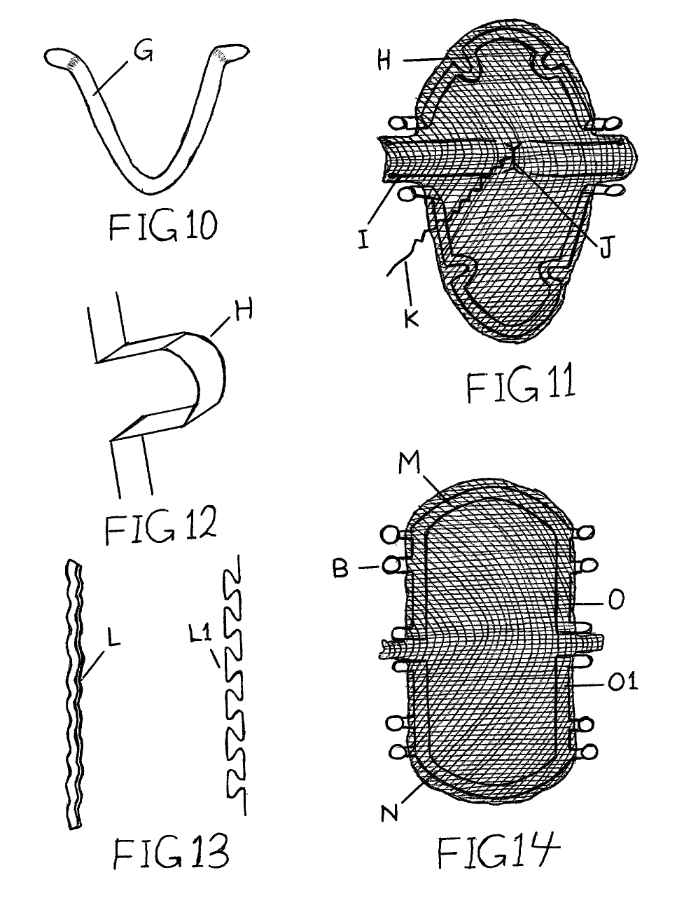

14) As mentioned above in the brief description of the drawings, FIG. 10 shows a ready made lower malleable metal frame (G) formed in the shape needed to simulate the anatomy of the parts of the mouth that it will touch. In other words, the shape of this frame is made to simulate the shape of the straight frame after it is bent to adapt to the anatomy of the mouth.

15) FIG. 11 shows additional ramifications: First: a thread (I, J, K) that is used to pull the angles of the gauze intraorally. In some situations there is a need to check the occlusion during a dental procedure, like when trying to fit a crown on a primary or permanent tooth. In other occasions it may be necessary to use occlusal forces to adapt a crown on a primary tooth or an orthodontic bands on permanent molars. In these circumstances we need to take the part of the gauze that may be covering part of the occlusal surfaces of the teeth out of occlusion. This can be done manually, but using the threads shown in FIG. 11 can do it easier. A thread (I) is tied to each angle of the part of the gauze that extends extraorally (A1). Each of these threads extends horizontally on the anterior aspect of the gauze, until it gets close to the midline where it penetrates the gauze from the anterior aspect to the posterior aspect then from the posterior aspect to the anterior aspect. After that it unites with the thread coming from the opposite side to form the thread (J), then it extends toward the center of the gauze to unite with the thread coming from the other jaw (upper and lower) to form one thread (K). When pulling this thread (K) it will pull threads (J) which in turn pull threads (I) and subsequently the angles of the gauze will be pulled intraorally when there is a need to check the occlusion or use occlusal force during dental procedures.

The second ramification is a U shaped bent (H) in the upper and lower frames to increase the adjustability of the frames and the device to the different sizes of different mouths.

FIG. 12 is a larger view of the U bent (H) mentioned above in the second ramification of FIG. 11.

16) FIG. 13 is a view of another ramification, the metal strips or frames (C), (D), and (G) mentioned in FIG. 3, FIG. 4, and FIG. 10 successively can be replaced with strips or frames that have the same shapes but are wavy (L) instead of being straight to increase the adjustability of these frames and the protector to the different sizes of different mouths. The frequency, height and shape of the waves can vary depending on the malleability of the metal used or the need.

For the design mentioned above in the detailed description of the invention, procedures usually should be on a tooth anterior to the tooth to which the device is attached to in that quadrant.

17) When working on the most posterior tooth in a quadrant, we need some ramifications of the design. Suppose that we are working on the right upper second molar, the lower rings can be attached to any 2 lower teeth in the 2 lower quadrants, one in each quadrant, while the right or both of the upper elastic rings will be attached to, say, the second premolars (bicuspids). About 3-7 mm after the upper frame leaves the tooth surface and starts adapting to the palate and being sandwiched in the gauze, mentioned in 2 above, the upper frame is bent buccaly after it is distal (behind) the upper second molars and then bent medially (and forward if we want to avoid the gag reflex as mentioned in 6 above) to meet its mirror image of the other side. FIG. 14 shows the readymade pre-shaped upper frame (M) with (O) as the distal extension.

18) When working on the lower most posterior tooth in a quadrant, we need another ramification of the design. Suppose that we are working on the right lower second molar. The upper rings can be attached to any 2 upper teeth (preferably posteriors) in the 2 upper quadrants, one in each quadrant, while the right or both of the lower elastic rings will be attached to, say, the second premolars (bicuspids). About 3-7 mm after the lower frame leaves the tooth surface and starts adapting to the lingual alveolar ridge, it is bent distally adapting to the lingual alveolar ridge or the floor of the mouth, and just before it extends distal (behind) the lower second molar it starts being sandwiched in the gauze mentioned in 2 above. After it is bent buccaly distal to the right second molar it is then bent medially then anteriorly to continue forward and medially on the lingual alveolar ridge or the floor of the mouth without impinging on it. In the midline, anterior to the frenum of the tongue and lingual to the lower tow central incisors it meets with the part of the frame on the other side which ends on the lingual gingival margin of a lower posterior tooth on the opposite side or distal to the left second molar if we want to use a symmetrical design. FIG. 14 shows the ready-made pre-shaped lower frame (N) with (O1) as the distal extension.

Examples when a design similar to this and the design mentioned in the previous point (17) above are suitable are: when extracting third and second molars, placing crowns on permanent second molars (and primary second molars before the eruption of the permanent first molars), and when putting orthodontic braces on first and second molars.

19) When the gauze mentioned in 2 above is replaced by a continuous sheet (without perforations) like a rubber dam, for example, the device can be used as an alternative to the conventional rubber dam for root canal treatment (not for the purpose of isolation but for the purpose of protection of the airways, lungs and the gastrointestinal tract). This is a good idea when it is impossible or difficult to use a rubber dam. Unfortunately, some dentists do not use the rubber dam during root canal treatment because it is time consuming and somewhat complicated and difficult to use, this exposes the life of the patients to danger. More than once dental patients did die because they aspirated root canal files because their dentists did not use a rubber dam. My protector mentioned here replacing the gauze with something similar to the rubber dam sheet is a fast, simple, and easy alternative to use by dentists who do not use rubber dam for root canal treatment.

20) In case there is no upper or lower posterior teeth to which the elastic ring will be attached in one of the quadrants, say the lower left, the left edge of the lower frame will not be attached to an elastic ring, instead it will be longer about 10-20 mm and will be adapted firmly to the alveolar ridge at that site, one or more additional elastic rings can be added along the lower frame, even on anterior teeth. to increase stability.(Not Shown)

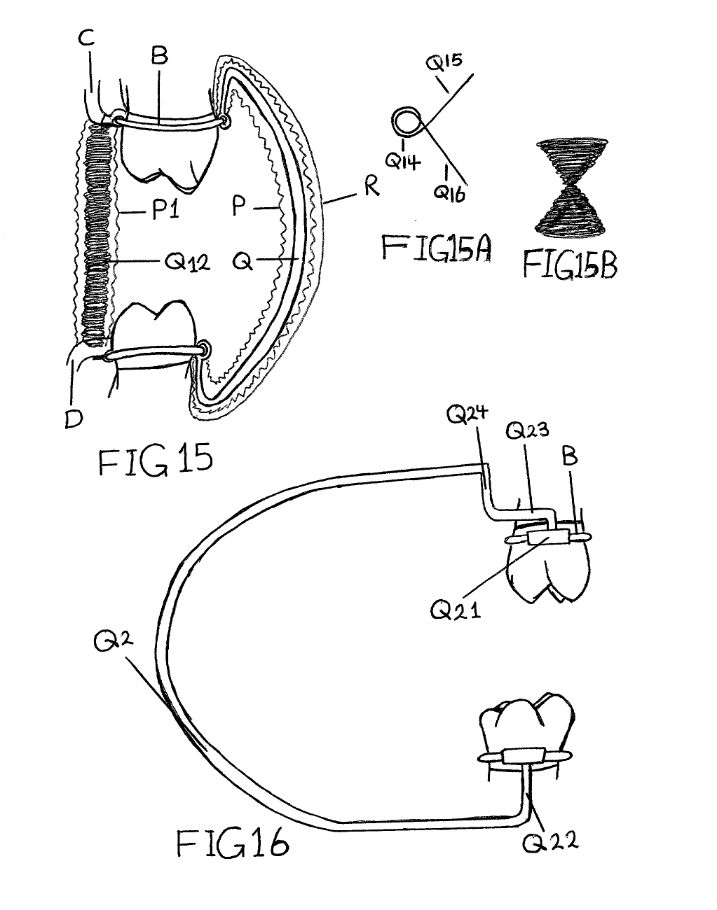

21) It is possible to increase the stability of the protector through an elastic plastic or metallic piece (Q), (Q12), (Q2), (Q1), and (Q11) that is attached to each of the upper and lower frames as shown in FIGS. 15, 15A, 15B, 16, 17, and 18. This piece can be a strip, a bar, a spring, . . . etc.

FIG. 15 shows an example of a buccal elastic piece. When we have rubber rings surrounding the teeth, this elastic piece will start by encircling the buccal part of the rubber ring that is attached to the upper tooth, then it goes upward along the upper alveolar ridge until it is close to the attachment of the buccinators muscle, that is close to the upper most area of the upper buccal sulcus. Then it goes downward and buccaly to simulate the anatomy of the inner side (R) of the cheek buccal to the tooth that is holding the protector. When the elastic piece reaches the level of the occlusal line, it continues downward and medially adapting to the anatomy of the inner side of the lower part of cheek buccal to the lower tooth holding the protector. The plastic piece then goes vertically upward adjacent to the buccal surface of the lower alveolar ridge till it ends around the lower elastic ring.

It is possible to make the length of the elastic piece adjustable according to the width of the opening of the patient. An example of this is using any belt-like design (the belt that is used to hold the trousers!)

FIG. 15A shows an elastic piece that can be adjusted either by changing the diameter of its ring (Q14) or by bending the arms (Q15) and (Q16) to fit the size or width of the opening of the patient's mouth. At the same time, it's elastic and will keep continuous pressure on the malleable frames to keep the air and food passages sealed while making it possible for the patient to press the elastic frames when he needs to bite or swallow. In this case of elastic piece, the elastic piece is attached to the frames through the peripheral endings of the arms (Q15) and (Q16) and usually parallel to the sagittal plane, but another design having them parallel to the coronal plane is also possible.

FIG. 15B is a view of a design for a spring elastic piece in which each ring goes inside the ring after it so that the spring will come very short when the patient closes her/his mouth, instead of bending and interfering with the tissues of the mouth. An example to achieve this is by making the diameter of the rings increase gradually from the middle to the periphery.

One important fact about these elastic pieces is that it is elastic enough to let the patient bite or swallow during the dental procedure. At the same time, they perform continuous pressure on the protector against the tissues of the patient (hard palate, cheek, lingual side of the alveolar ridge or floor of the mouth, etc . . . ) and this pressure is enough to keep the protector in it's place even when the patient opens his mouth wide and this pressure is not enough to hurt the patient.

It is possible to wrap these pieces with soft sheets or coverings (P) and (P1) like a gauze, cotton, wool, soft plastic or special type of paper to eliminate any potential risk of injuring the soft tissues of the patient.

Regarding the gauze (A), which is not shown in FIGS. 15-19 for clarification and simplification purposes, it can pass behind or in front of this elastic piece, it can sandwich it and continue extraorally or end around that piece.

When using the elastic piece, it is preferable to use it bilaterally, to enhance the stability and equilibrium of the protector, but it is also possible to use it unilaterally when needed.

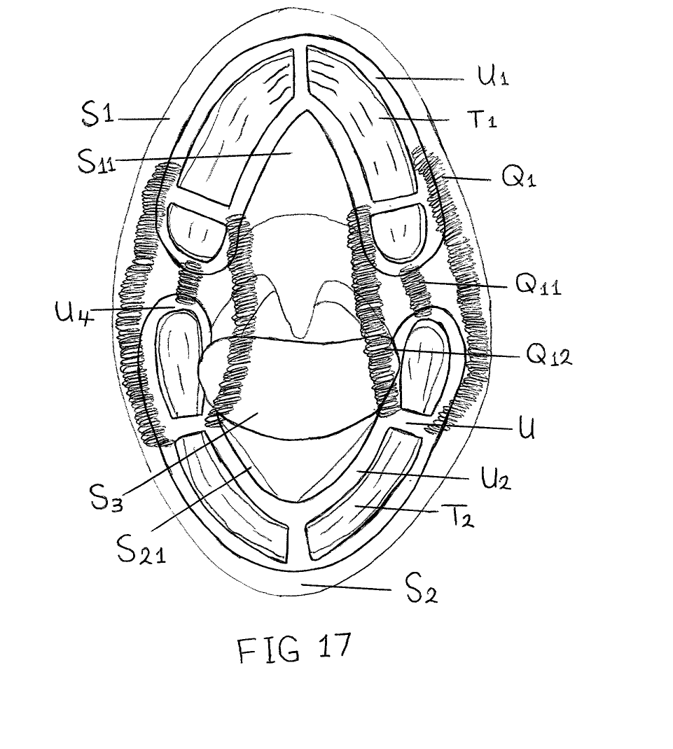

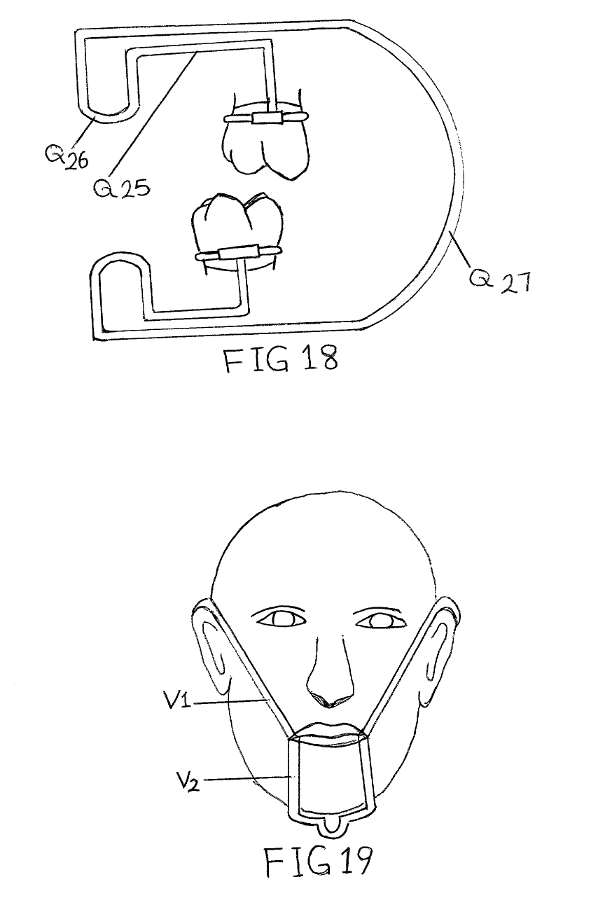

It is also possible to add this buccal metallic or plastic piece between the ends (the most posterior part) of the parts extending distally (O) and (O1) of frames (M) and (N) in FIG. 14. In such cases, these pieces are attached directly to the frames since we do not have rings, (Q11) in FIG. 17 is an example of a distal attachment, but it is shown in an edentulous patient here.

Additional attachments through the rings (B) are still possible in dentate patients.

Another possibility is to attach the elastic piece (P1) and (Q12) to the frames extending on the lingual and palatal sides of the alveolar ridges. In these circumstances, it is possible to cover the anterior tow thirds to the tongue with a cap attached to the protector and made of a material like that of the isolation rubber dam to eliminate any potential risk of harming it.

It is also possible to cover larger part of the palate or the floor of the mouth with the frame this will distribute the stress applied by the elastic pieces on a larger area, and increase stability. This is applicable to all designs discussed here.

FIG. 16 shows another design of an intraoral elastic piece, the bent made by (Q23) and (Q24) is to avoid any possible interference with the bony structures in that area whenever the patient opens or closes her/his mouth. It is possible to do hundreds of designs of this elastic piece; anything that does the job and does not interfere with other structures is OK.

It is also possible to take part of the elastic piece extraorally to get it out of the way of the dentist, it can extend in any direction, I prefer to have it go extraorally and then fit on the skin of the cheek, this will provide the dentist with large space and stabilize the protector more. The part (Q26) is designed to avoid stretching the lips and the cheek too hardly, nevertheless a cheek and lip retractor can be added as a part of the design, this is indicated usually in orthodontic patients during placing and removing bands and braces.

Elastic pieces that extend buccaly, either intra or extraorally, can be attached to the elastic rings, or directly to the frames, either to the buccal or distal parts in dentate or edentulous patients or even to the lingual part of the frame in edentulous patients or in dentate patients when we do not want to check the occlusion or we do not need to use occlusal forces.

It also possible to attach the gauze and the malleable frames to any dental probe (bite guard). This may be suitable in edentulous patients or mentally challenged patients. This can be done with or without the elastic pieces.

22) FIG. 17 is a view of a protector that can be used in edentulous patients during the process of getting implants. There are extensions (U) of the lingual frame (U2) connecting it with the buccal frame (U1), without interfering or covering the areas where the flaps will be raised or the implants will be inserted in the alveolar ridges (TI) and (T2). (S1) and (S2) are the upper and lower buccal sulci respectively, (S11) is the hard palate, (S21) is the lingual vestibule or sulcus. (S3) is the tongue. (Q1), (Q11) and (Q12) are the buccal distal, and lingual springs successively.

It is possible to use this design for dentate patient; we only need to remove the extensions (U) that connect buccal and lingual parts of the frames while leaving the most distal extension (U4) on both sides. Elastic rings can be added to this design. Usually, the gauze will not sandwich the buccal part of the frame.

23) An alternative to the design in FIG. 17 is that the edges of the frames expand over the alveolar ridge, parallel to the coronal plane, and then they are bent forward along an imaginary occlusal plane, and continue extraorally at the angle of the mouth. The upper frame is then tilted upward to be used for stability either by using elastics that surround the ears or by hooking the ends of the upper frame around the ears. Another alternative is to use the nose by connecting the ends of the upper frame around the bridge of nose. Another alternative is to use the head either by using elastics or passive connectors (threads, etc . . . ). For the lower frame, the following is needed. After the lower frame leaves mouth through the angle of the mouth it is bent downward until it reaches the lower border of the mandible. To stabilize the lower portion or frame the chin is used, either by using elastics that surround the chin, or by connecting the ends of the lower frame around the chin. An alternative to this is to use the neck to stabilize the lower portion, by using elastics or passive connectors (threads, etc . . . ) that surround the neck. The important thing in these extraoral designs is not to stretch the soft tissue of the angle of the mouth excessively. Also thicker and wider strips or frames may be needed to enhance stability. Furthermore, additional attachments can be added between the intraoral frame and the extraoral part for the same reason.

24) It is possible to make a notch in the frame or the elastic piece, or an opening in the gauze for the passage of the saliva ejector or suction, or attaching it to the protector in any way. If the opening is made in the gauze, it is preferred to have it surrounded by an elastic rubber ring to work as a sphincter, so that when nothing is passing through it, the opening will be almost completely closed, and when the saliva ejector is passing through the hole, the rubber ring will not allow anything from passing between the gauze and the ejector. Care need to be taken not to use a separate end of the ejector tip in this situation.

25) Despite the fact that the design of all these protectors allows them to be highly adjustable to different sizes. It is necessary to produce it in different sizes, at least three.

26) It is possible to wrap or cloth the frames and the elastic pieces or their edges with soft material like additional gauze, cotton, wool, plastic, paper, . . . etc, to decrease any possibility of trauma to the soft tissues, and ensure complete seal between the device and the oral tissues.

27) The part of the gauze enclosing the frames, or the soft sheet covering the frames can be moisten with local (topical) anesthetic to decrease any possibility of a gag reflex or pain.

28) It is also possible to attach cotton rolls to any part of the frames or the gauze to increase its ability as an isolation device (suck the saliva), this is a secondary function of the device.

29) It is also possible to add Fixodent or any other adhesive material at the margins of the protector to increase stability and ensure perfect seal.

30) It is possible to attach each elastic ring with tow threads (S) as shown in FIG. 16, to make it easier to stretch the rings in an area where it is difficult for the fingers of the dentist to get in, especially in the upper posterior area.

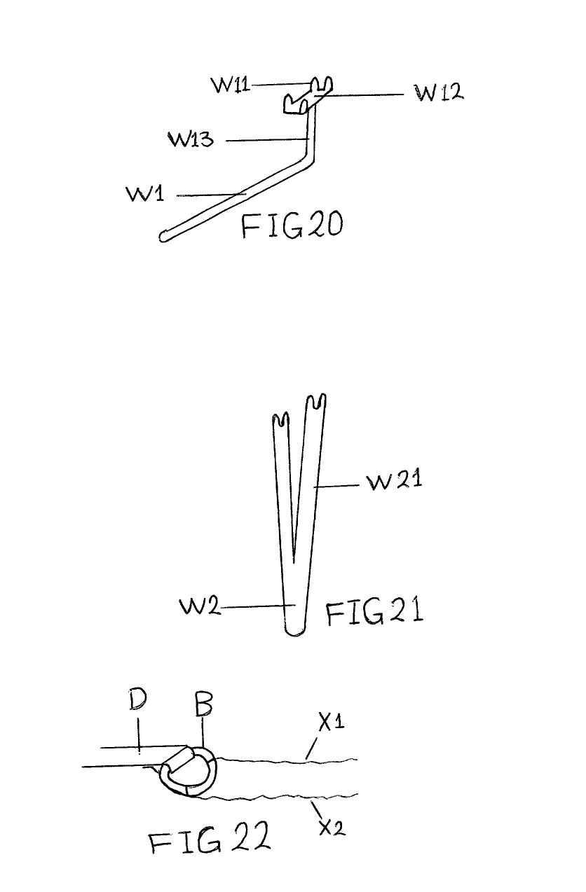

31) It is possible to use a metallic or plastic instrument (W1) or (W2) shown in FIGS. 20 and 21 to aid in inserting the rings around the teeth. The tow tips of the instrument (W11) and (W111) are inserted in the ring; the elastic ring is then stretched by pulling the instrument (W1) away from the protector, keeping the tips of instrument slightly tilted laterally. After the ring is flossed between the desired teeth, the tips of instrument are bent medially (toward the tooth) and the tips are moved occlusally and out of the ring, leaving the ring around the tooth.

32) FIG. 20 shows a bent between (W13) and the long handle of (W1), this is an alternative to the straight design (without a bent); this bent may make the procedure easier.

33) FIG. 21 shows a tweezers-like design which help in adjusting the distance between the tips of (W21) during the procedure to make it fit the mesio-lingual width of the crown of the tooth to be used for attaching the protector. This design can also be angled.

34) FIG. 23 is a view of tow instruments used in the removal of the elastic rings (B) from around the teeth. (Y1) is used to remove the elastic ring intact by inserting the tow tips (Y11) and (Y12) between the tooth and the ring and pulling occlusally. (Y2) is used to cut the ring by the blade (Y21) after inserting the tip between the tooth and the ring, this may be needed when it is difficult to remove the ring intact. All the possible designs of (W1) and (W2) apply for (Y1) and (Y2).

35) When trying to decrease the cost of the materials used, some parts like the frames, elastic pieces, . . . etc, can be used more than once while the gauze and the rubber rings will be disposable. A clamp-like design can be added to the edges of the frames, elastic pieces, . . . etc, as shown in FIG. 24. When the tip (Z1) of the handle (Z) of the is pushed against the spring (Z2), the other tip (Z3) is pushed away from the tip (Z13) of the other handle of the clamp, which is also the extension of the frame, for example. This will cause gate (Z5) to open. The rubber ring or part of the gauze is then passed though the gate and hooked in the hook (Z4) and/or grasped by the teeth of the gate of (Z5) when the tip (Z1) is released. Additional clamps, or other hooking devices can be added on the frames and other parts of the protector as needed.

36) It is also possible to use the gauze and the elastic rings alone without the frames. I do not recommend this.

37) Although it is practically impossible to aspirate or ingest the protector itself by the patient, I prefer to attach it to a thread as an additional safety precaution, so that if the protector is aspirated or ingested the thread will help the dentist pull the protector out.

38) While my above description contains many specifications, these should not be constructed as limitations, but rather as an exemplification of variation; any possible combination of any of the above points, items, parts, or ideas is part of my protection system. For example we can combine

A U bent, with

A prefabricated frame, with

A wavy design of the frames, with

More than 4 elastic rings, with

The parts (O) and (O1) extending posteriorly beyond the teeth to which the protector is attached to, with

Additional extraoral stability, with

Threads, with

Replacing the gauze with a continuous sheet like a rubber dam. With

Etc . . .

This is only one example. Accordingly, the scope of the invention should be determined not by the embodiments illustrated, but by the appended claims and their legal equivalent.

1) What I claim as my invention is the ornamental basic design of the airways, lungs, and gastrointestinal tract protection system against aspiration and ingestion in conscious and consciously sedated dental patients as described and shown, mainly in FIG. 5.

2) What I claim as my invention is the ornamental design of the protector with the ramification of using ready made or pre-shaped frames that adapt immediately to the areas of the oral cavity that they extend over without the need to do much bending as described and shown. This can be applied to all frames mentioned in these specifications.

3) What I claim as my invention is the ornamental design protector with the ramification of adding the U bent to the frames as described and shown mainly in FIG. 11 and FIG. 12 and/or using wavy rather than straight frames as described and shown mainly in FIG. 13. This can be applied to all kinds of frames mentioned, including but not limited to, the ready-made pre-shaped frames.

4) What I claim as my invention is the ornamental design of the protector with the ramification of adding the threads to pull the extraoral part of the gauze intraorally as described and shown mainly in FIG. 11.

5) What I claim as my invention is the ornamental design of the protector with the ramification of adding the distal extension (O) and (O1) to the frame as described and shown mainly in FIG. 14.

6) What I claim as my invention is the ornamental design of the protector with the ramification of replacing the gauze with a continuous sheet like a rubber dam sheet, for example, as described.

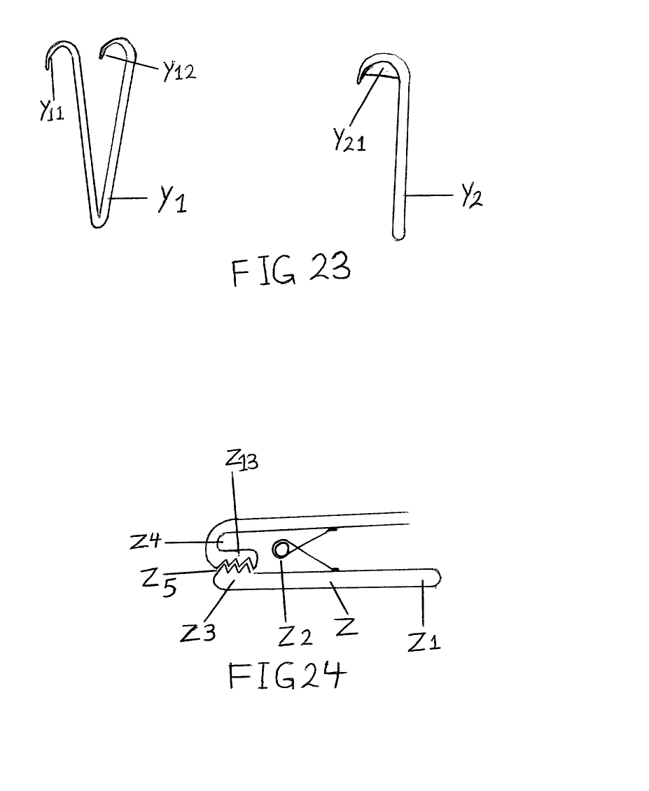

7) What I claim as my invention is the ornamental design of the protector with the ramification of attaching the elastic rings to tow threads as described and shown in FIG. 22.

8) What I claim as my invention is the ornamental design of the protector with the ramification of using one or more intraoral or extraoral elastic piece as described and shown mainly in FIGS. 15,16, 17 and 18.

9) What I claim as my invention is the ornamental design of the protector with the ramification of using an extraoral extension of the frames as described and shown mainly in FIG. 19.

10) What I claim as my invention is the ornamental design of the protector with the ramification of attaching cotton rolls or pieces anywhere on the frames or the gauze, wrapping or clothing any part that is potentially harmful to the soft tissues, using topical anesthetic, using Fixodent, or attaching cheek and lip retractors to the protector or making a notch in the frame or the elastic piece, or an opening in the gauze for the passage of the saliva ejector or suction, or attaching it to the protector in any way as described in the detailed description of the invention

11) What I claim as my invention is the ornamental design of the protector with the ramification of using the clamp-like design for the frames and/or the elastic pieces for the attachment with the rubber rings and/or the gauze as described and shown mainly in FIG. 24, or using any method to attach the gauze to the other components temporarily. This point is about non-disposable parts of the protectors like the frame, the elastic piece, . . . etc.

12) What I claim as my invention is the design of the protector with the ramification of changing the number, size, length, width, thickness or any other measured value or adding or omitting or changing the position of or altering any of the components as mentioned or shown.

13) What I claim as my invention is the design of the protector with any ramifications or modifications or alteration as described, mentioned, shown, or implied. There are hundreds of possible combinations in this system; any possible combination is part of my invention.

14) What I claim as my invention are the special instruments used to insert and remove the elastic rings as described and shown mainly in FIGS. 20, 21, and 23.
